(19) United States
(12) Patent Application Publication
(10) Pub. No.: US 2009/0022438 A1
(43) Pub. Date: Jan. 22, 2009

(54) BEARING ASSEMBLY, MOTOR, AND DISK DRIVE

(75) Inventor: Takehito TAMAOKA, Kyoto (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: NIDEC CORPORATION, Minami-ku (JP)

(21) Appl. No.: 11/960,901

(22) Filed: Dec. 20, 2007

(30) Foreign Application Priority Data
Dec. 27, 2006 (JP) 2006-351342

(51) Int. Cl. F16C 35/02; H02K 5/16

(52) U.S. Cl. 384/112; 310/90

(57) ABSTRACT

A sleeve and a sleeve housing are bonded to each other with adhesive. A thrust dynamic pressure bearing portion is configured between a thrust plate attached to a distal end of a shaft and the lower end surface of the sleeve. An annular step portion having a smaller diameter is provided at the lower side of the sleeve housing, and the annular step portion meets the sleeve. An annular raised portion is provided between thrust dynamic pressure grooves on the lower end surface of the sleeve and the annular step portion. In this configuration, the surplus adhesive leaked from between the sleeve and the annular step portion can be blocked by the annular raised portion, thereby preventing the adhesive from flowing into the thrust dynamic pressure bearing portion.

### BACKGROUND OF THE INVENTION

1. Field of the Invention

The present invention relates to a bearing assembly utilizing a hydrodynamic pressure, a motor including the bearing assembly, and a disk drive.

2. Description of the Related Art

Conventionally, a disk drive such as a hard disk drive includes a spindle motor for rotating a disk-shaped storage medium. A bearing assembly utilizing a hydrodynamic pressure is typically selected for use in such a motor out of multiple types of bearing assemblies.

In Japanese Patent Unexamined Publication No. 2006-77872 and its counterpart U.S. Patent Publication No. US 2006/0051001 A1, for example, a hub portion of a rotor faces a sleeve and a housing accommodating the sleeve which both constitute a portion of a bearing, so that a thrust dynamic pressure is generated within a thrust gap formed between the hub portion and the sleeve. Lubricant oil is circulated through a communicating path or groove provided on the outer periphery of the sleeve. To facilitate the circulation, an annular gap between the hub portion and the housing is formed to be larger than the thrust gap disposed on the side of the central axis.

Adhesive, for example, is used for fixing the sleeve and the sleeve housing surrounding the outer periphery of the sleeve, both of which constitute a portion of a bearing utilizing a hydrodynamic pressure. In a case where adhesive is applied on the inner surface of the sleeve housing and the sleeve is inserted into the sleeve housing, the surplus adhesive is so retained that it will be attached to the bottom of the sleeve when the assembly is completed.

In this case, if the adhesive is supplied too much, the adhesive may flow down over the surface of the sleeve to leak out onto the lower surface of the sleeve and adhere to a dynamic pressure producing groove provided on the lower surface of the sleeve. The adhesive that has become solidified in this state may scrape against a thrust plate opposing the lower surface of the sleeve with a gap therebetween.

On the other hand, if the amount of the adhesive is reduced, adhesive strength may degrade in some bearing assemblies because of the difficulty in controlling the amount of adhesive, with the result that the sleeve and the sleeve housing may easily be detached with just small external force.

### SUMMARY OF THE INVENTION

According to preferred embodiments of the present invention, a fluid dynamic pressure bearing assembly includes a shaft, a sleeve, a thrust plate extending radially outward from the outer peripheral surface of the shaft, and a sleeve housing disposed radially outside the sleeve so as to surround the sleeve.

The sleeve housing has a hollow portion which is substantially cylindrical, for example, and a step portion which is approximately annular and protrudes inward from the hollow portion.

The sleeve is fixed to the sleeve housing with adhesive, and the lower end surface of the sleeve axially opposes the thrust plate with a lower gap therebetween. On the lower end surface of the sleeve which configures the lower gap, an adhesive stopping feature in the form of a raised or recessed portion, which is approximately annular, for example, is provided between the outer peripheral edge of the lower end surface of the sleeve and a region thereon constituting the lower gap.

According to preferred embodiments of the present invention, it is possible to prevent the adhesive from flowing into a thrust dynamic pressure bearing portion from between the sleeve and the sleeve housing, in assembling the bearing assembly.

It is also possible to prevent the adhesive from spreading into a region inside the step portion while avoiding contact between the step portion and the raised portion as the adhesive stopping feature.

Further, it is possible to easily increase the radial dimension of thrust dynamic pressure grooves.

Other features, elements, advantages and characteristics of the present invention will become more apparent from the following detailed description of preferred embodiments thereof with reference to the attached drawings.

### BRIEF DESCRIPTION OF THE DRAWINGS

FIG. 1 is a cross-sectional view of a disk drive according to a first preferred embodiment of the present invention.

FIG. 2 is a longitudinal cross-sectional view of a motor according to the first preferred embodiment of the present invention.

FIG. 3 is an enlarged longitudinal cross-sectional view of a portion of the motor.

FIG. 4 is a plan view of a sleeve of the motor of FIG. 2.

FIG. 5 is a longitudinal cross-sectional view of the sleeve of FIG. 4.

FIG. 6 is a bottom view of the sleeve of FIG. 4.

FIG. 7 is an enlarged view of a portion of a bearing assembly.

FIG. 8 is an enlarged view of another portion of the bearing assembly.

FIG. 9 is a bottom view of a sleeve of a bearing assembly according to a second preferred embodiment of the present invention.

FIG. 10 is an enlarged view of a portion of the bearing assembly.

FIG. 11 shows a variant of the bearing assembly according to the second preferred embodiment.

FIG. 12 shows another variant of the bearing assembly according to the second preferred embodiment.

FIG. 13 shows a variant of the bearing assembly according to the first preferred embodiment.

FIG. 14 is an enlarged view of a portion of a bearing assembly according to a third preferred embodiment of the present invention.

FIG. 15 is an enlarged view of a portion of a bearing assembly according to a fourth preferred embodiment of the present invention.

FIG. 16 is an enlarged view of a portion of a bearing assembly according to a fifth preferred embodiment of the present invention.

FIG. 17 shows a variant of the bearing assembly according to the fifth preferred embodiment.

FIG. 18 is an enlarged view of a portion of a bearing assembly according to a sixth preferred embodiment of the present invention.

FIG. 19 is an enlarged view of a portion of a bearing assembly according to a seventh preferred embodiment of the present invention.

FIG. 20 is an enlarged view of a portion of a bearing assembly according to an eighth preferred embodiment of the present invention.

### DETAILED DESCRIPTION OF PREFERRED EMBODIMENTS

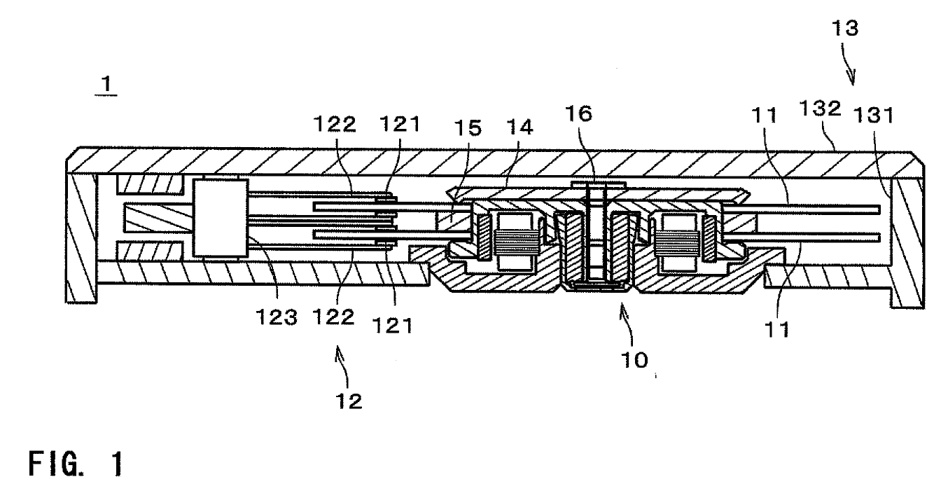

Referring to FIGS. 1 through 20, preferred embodiments of the present invention will be described in detail. It should be noted that in the explanation of the present invention, when positional relationships among and orientations of the different components are described as being up/down or left/right, ultimately positional relationships and orientations that are in the drawings are indicated; positional relationships among and orientations of the components once having been assembled into an actual device are not indicated. Meanwhile, in the following description, an axial direction indicates a direction parallel to a center axis, and a radial direction indicates a direction perpendicular to the center axis.

### First Preferred Embodiment

FIG. 1 is a cross-sectional view of a disk drive 1 including an electric spindle motor (hereinafter referred to as a “motor”) according to a first preferred embodiment of the present invention. In this preferred embodiment, the disk drive 1 is a hard disk drive and includes two circular disk-shaped storage media 11 capable of storing data, an access unit 12, the motor 10, and a housing 13. Hereinafter, the disk-shaped storage medium is simply referred to as a “disk”.

The access unit 12 carries out at least one of writing data on and reading data from the disks 11. The disks 11 spin when the motor 10 rotates. The housing 13 houses the disks 11, the access unit 12, and the motor 10 in its internal space.

The housing 13 has a first and a second housing members 131 and 132. In this preferred embodiment, the first housing member 131 is approximately cup-shaped, and the second housing member 132 has an approximately plate-like shape. The first housing member 131 has an opening at its top, and is mounted with the motor 10 and the access unit 12 on its inner bottom surface. The second housing member 132 covers the opening of the first housing member 131 to create the internal space.

In the disk drive 1, the housing 13 is constructed by joining the first and second housing members 131 and 132, and its internal space is an almost dustless clean space.

The two disks 11 are placed on the motor 10 with a spacer 15 interposed therebetween, and fixed to the motor 10 with a screw 16 and a clamp 14.

The access unit 12 has magnetic heads 121, arms 122 supporting the heads 121, and a head moving portion 123. The magnetic heads 121 operate very close over the disks 11 for reading data from and/or writing data on the respective disks 11. The head moving portion 123 moves the arms 122 so as to relatively move the heads 121 with respect to the disks 11 and the motor 10. In this manner, the heads 121 move in immediate proximity to the spinning disks 11 to access required positions on the disks 11, whereby data is written and/or read.

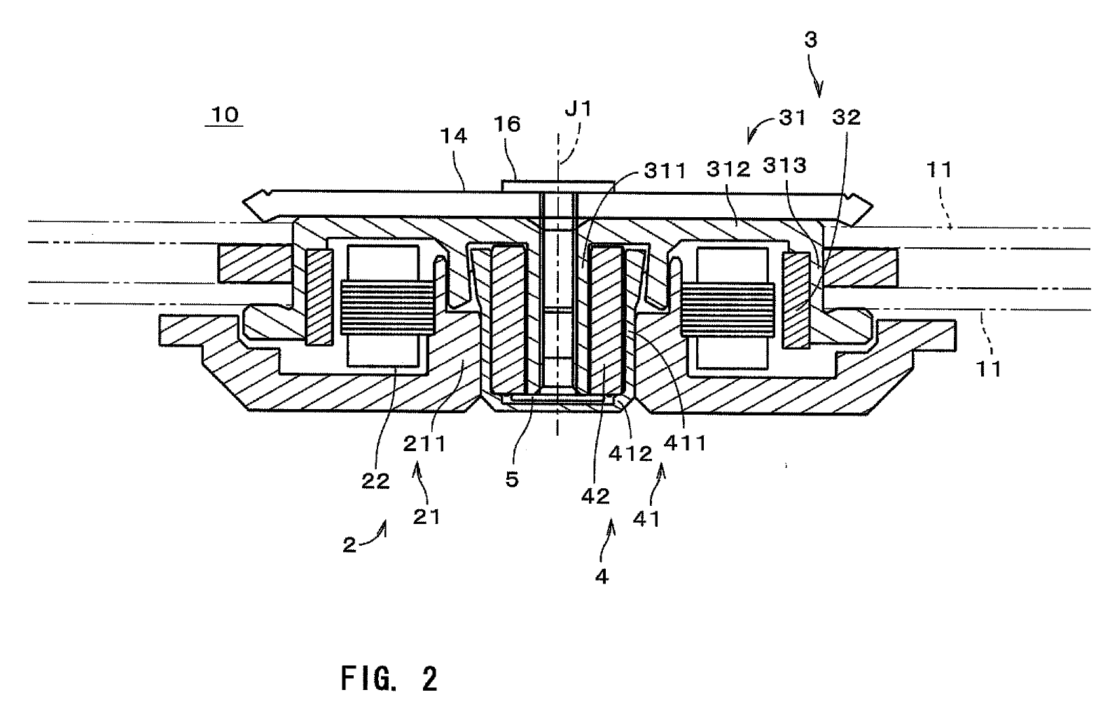

FIG. 2 is a longitudinal cross-sectional view of the motor 10, where the two disks 11 are illustrated with alternate long and two short dashes lines. The motor 10 is an outer rotor motor, and includes a stationary portion 2, a rotor portion 3, and a bearing assembly 4 utilizing a hydrodynamic pressure of lubricant oil as a working fluid.

The rotor portion 3 is supported in a rotatable manner about a center axis J1 of the motor 10 relative to the stationary portion 2 via the bearing assembly 4. In the description below, the side of the rotor portion 3 is referred to as an upper side and the side of the stationary portion 2 is referred to as a lower side with respect to the center axis J1 for convenience sake; however, the center axis J1 need not be coincident with the direction of gravitational force.

The rotor portion 3 includes a rotor hub 31 as a main body of the rotor portion 3. In this preferred embodiment, the rotor hub 31 is made of stainless steel, for example. The rotor hub 31 has a shaft 311, a circular disk portion 312 in the form of an approximately circular disk shape, for example, and a tubular portion 313 which is hollow and approximately cylindrical in this preferred embodiment.

In this preferred embodiment, the shaft 311 is hollow and approximately cylindrical and centered on the center axis J1. The shaft 311 extends downward, as shown in FIG. 2. The circular disk portion 312 stretches out from the upper end of the shaft 311 in a radial direction substantially perpendicular to the center axis J1. The tubular portion 313 protrudes downward from the outer periphery of the circular disk portion 312.

A rotor magnet 32 is fixed on the inner side surface of the tubular portion 313. A screw hole is formed substantially at the center of the shaft 311 to penetrate through the shaft 311. A screw portion of a thrust plate 5 is screwed on the lower end of the shaft 311. The thrust plate 5 has a circular disk-like shape that extends radially outward from the center axis J1. The screw 16 is fastened at the upper side of the screw hole to fix the clamp 14 on the circular disk portion 312. As will be described later, the shaft 311 and the thrust plate 5 serve as part of the bearing assembly 4 utilizing a hydrodynamic pressure, and the rotor portion 3 is attached to the upper end of the shaft 311 and rotated therewith.

The stationary portion 2 includes a base bracket 21 having a hollow, approximately cylindrical holder 211 substantially at its center, and a stator 22 attached around the holder 211. A sleeve housing 41 having a bottomed, hollow, and approximately cylindrical shape, for example, is inserted into the holder 211 and is fixed to the holder 211. The stator 22 radially opposes the rotor magnet 32 to generate a rotational force (torque) centered on the center axis J1 with the rotor magnet 32.

The bearing assembly 4 includes a sleeve 42 into which the shaft 311 is inserted, and the sleeve housing 41 which is arranged outside the sleeve 42 and the thrust plate 5 so as to cover the outer peripheries of the sleeve 42 and the thrust plate 5. The thrust plate 5 is attached to the lower end of the shaft 311, so that the top surface of the thrust plate 5 opposes the lower end of the sleeve 42. Since the shaft 311 and the thrust plate 5 form a gap in which a hydrodynamic pressure is generated, these components also constitute the bearing assembly 4. In this preferred embodiment, the sleeve 42 is a porous member made from sintered metal, and is impregnated with the lubricant oil.

The sleeve housing 41 has a hollow portion 411 which is approximately cylindrical, for example, and a step portion 412 in the form of an approximately annular step located below the hollow portion 411. The top surface of the step portion 412 extends radially inward from the inner side surface of the hollow portion 411. The hollow portion 411 receives the sleeve 42 with a gap therebetween, and is bonded to the outer surface of the sleeve 42 with adhesive. The step portion 412 is smaller in inner diameter than the hollow portion 411. The thrust plate 5 is arranged radially inside the step portion 412. The thrust plate 5 has a smaller diameter than the inner diameter of the wall portion of the step portion 412 which faces the thrust plate 5, so that the thrust plate 5 can be located radially inside the step portion 412.

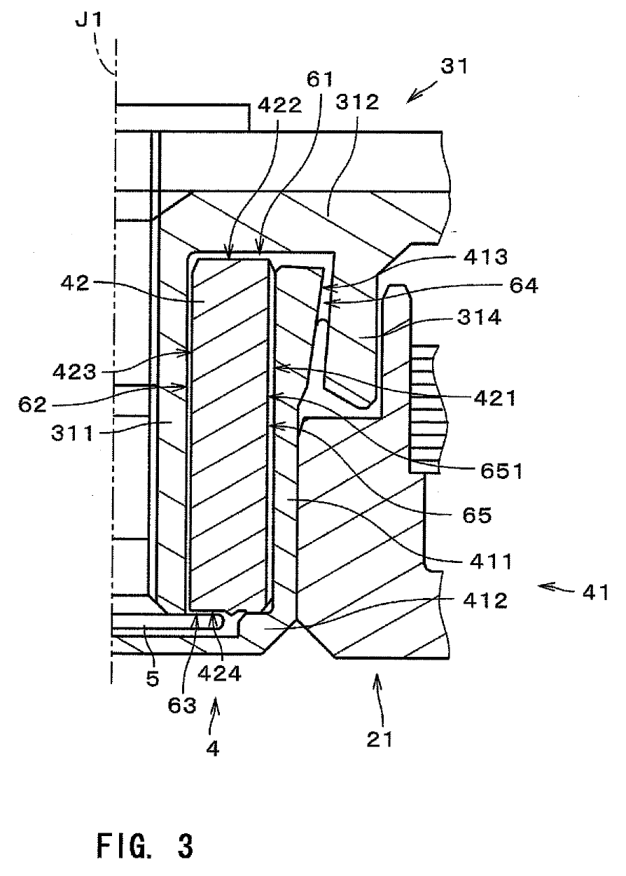

FIG. 3 is an enlarged cross-sectional view a portion of the motor 10. FIG. 3 shows the right half of the motor 10 in FIG. 2. An upper gap 61, a side gap 62, a lower gap 63, and an outer gap 64 are formed in the motor 10. The upper gap 61 is defined between the lower surface of the circular disk portion 312 of the rotor hub 31 and the upper end surface 422 of the sleeve 42. The side gap 62 is defined between the inner side surface 423 of the sleeve 42 and the outer side surface of the shaft 311. The lower gap 63 is defined between the lower end surface 424 of the sleeve 42 and the top surface of the thrust plate 5. The outer gap 64 is defined between the upper portion of the outer side surface 413 of the sleeve housing 41 and the inner surface of a protruding portion 314. The protruding portion 314 protrudes downward from the circular disk portion 312 in the radially outside of the sleeve housing 41, as shown in FIG. 3, and is approximately annular, for example.

A plurality of grooves 651 are provided substantially parallel to the center axis J1 on the outer side surface 421 of the sleeve 42. When the sleeve 42 is inserted into the sleeve housing 41 and the inner side surface of the hollow portion 411 of the sleeve housing 41 surrounds the outer side surface 421 of the sleeve 42, the grooves 651 form a plurality of flow passages 65 in the axial direction between the outer side surface 421 of the sleeve 42 and the sleeve housing 41. The flow passages 65 connect the upper gap 61 to the lower gap 63 each other. Another flow passage is provided between the sleeve 42 and the step portion 412, as will be described later.

The flow passages 65 and the gaps 61 to 64 are continuously filled with lubricant oil in an uninterrupted manner in the motor 10. The width of the outer gap 64, i.e., the distance between the outer side surface 413 of the sleeve housing 41 and the inner surface of the protruding portion 314 of the rotor hub 31, gradually increases as it moves from the upper end of the sleeve housing 41 downward. With this structure, a tapered seal, in which the interface of the lubricant oil forms a meniscus, is formed in the outer gap 64, so that leakage of the lubricant oil is prevented. In other words, the outer gap 64 acts as an oil buffer.

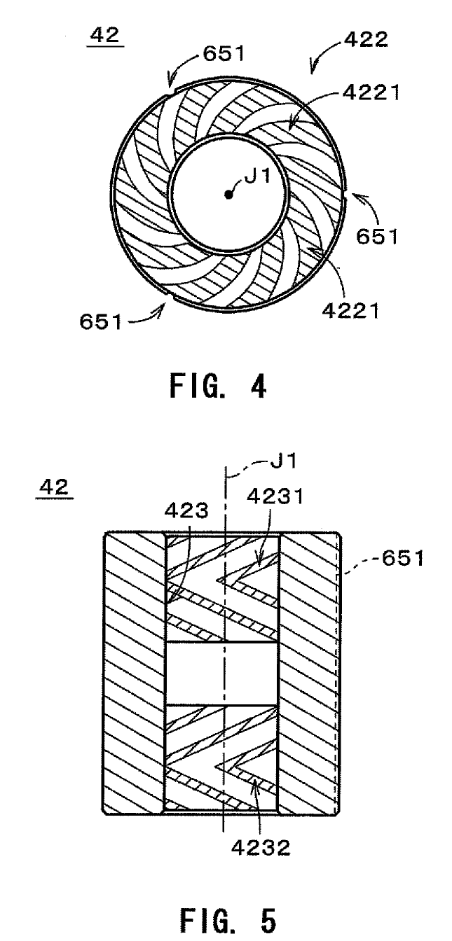

FIG. 4 is a plan view of the sleeve 42. A group of thrust dynamic pressure grooves 4221 are provided in the upper end surface 422 of the sleeve 42. In this preferred embodiment, the thrust dynamic pressure grooves 4221 are spiral grooves. In FIG. 4, the bottom surfaces of the thrust dynamic pressure grooves 4221 are hatched. At the upper gap 61, a thrust dynamic pressure bearing portion is formed in which the thrust dynamic pressure grooves 4221 produce a pressure that acts on the lubricant oil to make it move radially inward during rotation of the rotor portion 3.

FIG. 5 shows a cross section of the sleeve 42 taken along a plane including the center axis J1. Groups of a plurality of radial dynamic pressure grooves 4231 and 4232 are provided in the upper region and the lower region of the inner side surface 423 of the sleeve 42, respectively. In this preferred embodiment, the radial dynamic pressure grooves 4231 and 4232 are herringbone grooves. In FIG. 5, the bottom surfaces of the radial dynamic pressure grooves 4231 and 4232 are hatched. At the side gap 62, a radial dynamic pressure bearing portion is configured in which the radial dynamic pressure grooves 4231 and 4232 generate a hydrodynamic pressure while the motor 10 is operating. In addition, as shown in FIGS. 4 and 5, the grooves 651 extending substantially along the center axis J1 are provided on the outer periphery of the sleeve 42, as have been described, at substantially equal intervals. In this preferred embodiment, three grooves 651 are provided.

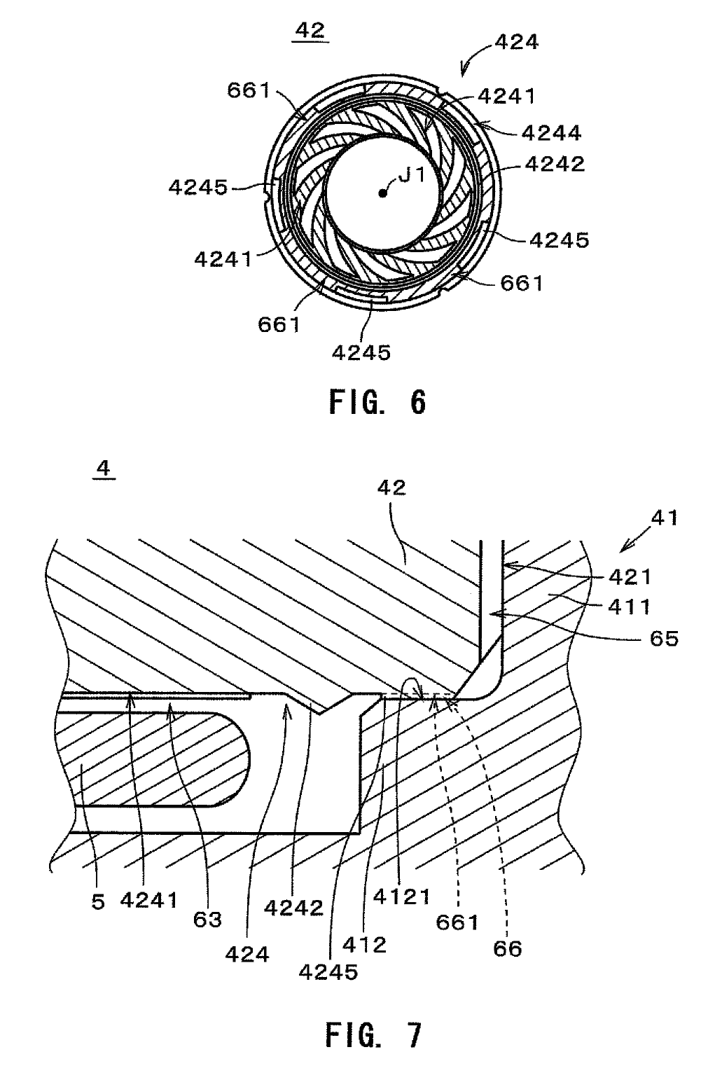

FIG. 6 is a bottom view of the sleeve 42. Thrust dynamic pressure grooves 4241 are provided in a radially inner region of the lower end surface 424 of the sleeve 42. The thrust dynamic pressure grooves 4241 oppose the thrust plate 5 (see FIG. 3), thereby configuring a thrust dynamic pressure bearing portion which can generate a pressure that acts radially inwardly between the thrust plate 5 and the sleeve 42 during rotation of the rotor portion 3.

A raised portion 4242 is provided on the lower surface 424 between the thrust dynamic pressure grooves 4241 and the outer peripheral edge 4244 of the lower end surface 424. In this preferred embodiment, the raised portion 4242 is approximately annular and centered on the center axis J1 when viewed along the axial direction. A plurality of projections 4245 are provided at equal intervals along a substantially identical circumference in the outer peripheral portion of the lower end surface 424, i.e., the portion adjacent to the outer peripheral edge 4244 between the raised portion 4242 and the outer peripheral edge 4244 on the lower end surface 424. The outer peripheral edge 4244 is chamfered in this preferred embodiment.

In the regions circumferentially between the adjacent projections 4245, namely one of the hatched regions which is located between the raised portion 4242 and the outer peripheral edge 4244 in FIG. 6, a plurality of grooves 661 are formed which extend from the raised portion 4242 to the outer peripheral edge 4244.

Note that the grooves 661 are partially linked with one another and have substantially the same depth as that of the thrust dynamic pressure grooves 4241. Moreover, the number of the projections 4245 and the number of the grooves 661 are not limited to those shown in FIG. 6, and may be one or more.

FIG. 7 is an enlarged cross-sectional view of a lower right portion of the sleeve housing 41 and the sleeve 42 shown in FIG. 2. When the sleeve 42 is inserted into the sleeve housing 41 in assembling the bearing assembly 4, the projections 4245 on the lower end surface 424 of the sleeve 42 come into contact with the top surface 4121 of the step portion 412 of the sleeve housing 41, as shown in FIG. 7. In this state, the grooves 661 (see FIG. 6) provided circumferentially between the projections 4245 form a plurality of flow passages 66 between the lower end surface 424 of the sleeve 42 and the step portion 412. Each flow passage 66 extends radially and has a circumferential length.

In the motor 10, the flow passages 66, the flow passages 65 between the outer side surface 421 of the sleeve 42 and the inner side surface of the hollow portion 411 of the sleeve housing 41, and the gaps 61, 62, and 63 collectively configure circulating paths for circulating the lubricant oil.

While the rotor portion 3 is rotating, the lubricant oil circulates through the circulating paths, and the rotor portion 3 is supported by the hydrodynamic pressure generated by the thrust dynamic pressure grooves 4221 and 4241 and the radial dynamic pressure grooves 4231 and 4232. The thrust dynamic pressure grooves 4241 face the thrust plate 5 over their entire surface.

The lubricant oil circulates in such a manner that it runs through the side gap 62 and then the lower gap 63, past the flow passages 66 as the first communicating flow passages, the flow passages 65 as the second communicating flow passages, and the upper gap 61, to return to the side gap 62. As described above, the flow passages 66 are defined by the grooves 661 as the first communicating grooves provided in the lower end surface 424 of the sleeve 42. The flow passages 65 are defined by the grooves 651 as the second communicating grooves provided in the outer side surface 421 of the sleeve 42.

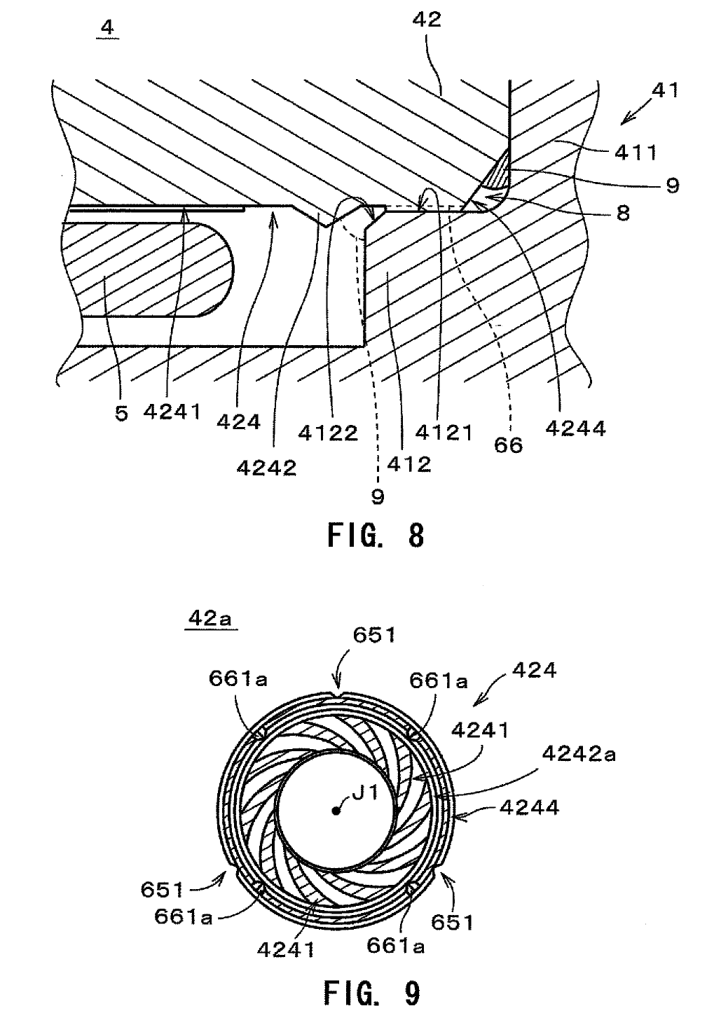

FIG. 8 is a cross-sectional view showing a portion of the bearing assembly 4 where the flow passage 65 is not provided. The portion shown in FIG. 8 corresponds to a lower-right portion of the bearing assembly 4 when cut by a plane including the center axis J1, as in FIG. 7. As shown in FIGS. 7 and 8, the raised portion 4242 provided on the lower end surface 424 of the sleeve 42 has a substantially inverted triangular shape in cross section with its lower side projecting in V-shape. The raised portion 4242 faces the step portion 412 with a gap therebetween. Also, the raised portion 4242 faces the thrust plate 5 with a gap interposed therebetween. In the sleeve 42 of FIG. 8, the height of the raised portion 4242 is larger than the depth of the thrust dynamic pressure grooves 4241 in the axial direction. Specifically, the depth of the thrust dynamic pressure grooves 4241 is in the range of about 10 to about 14 μm, and the height of the raised portion 4242 is in the range of about 30 to about 40 μm.

Alternatively, the height of the raised portion 4242 may be substantially the same as the depth of the thrust dynamic pressure grooves 4241 in the axial direction. In this case, the height of the raised portion 4242 is small, but the design for press molding of the sleeve 42 (forging may be conducted either) can be facilitated.

In combining the sleeve 42 and the sleeve housing 41 with each other, the sleeve 42 is first fitted around the shaft 311, and the thrust plate 5 is screwed at a distal end of the shaft 311. Subsequently, adhesive is applied on an upper portion of the inner side surface of the hollow portion 411, and then the sleeve 42, together with the shaft 311 and the thrust plate 5, are inserted into the sleeve housing 41. In this manner, the adhesive spreads over to the lower side of the sleeve housing 41.

When the sleeve 42 is inserted until its lower end surface 424 touches the step portion 412 of the sleeve housing 41, the surplus adhesive 9 that was unable to stay in between the sleeve 42 and the sleeve housing 41 pools in a space 8 defined by the outer peripheral edge 4244 of the lower end surface 424, the inner side surface of the hollow portion 411 of the sleeve housing 41, and the top surface 4121 of the step portion 412, to be retained there.

At this time, the surplus adhesive 9 is drawn by capillary action to leak radially inside beyond the step portion 412 when the surplus adhesive 9 is partially increased in amount. Even in such a case, the surplus adhesive 9 can be blocked by the raised portion 4242 as the adhesive stopping feature on the lower end surface 424 as shown with the broken line, in the bearing assembly 4. Also, a slant surface 4122 is provided on the upper edge of the inner peripheral surface of the step portion 412, that is, the upper edge of the inner peripheral surface of the step portion 412 is chamfered. Thus, an even larger amount of the surplus adhesive 9 can be held by the slant surface 4122.

Since the raised portion 4242 prevents the radially inward spreading of the adhesive 9, the adhesive 9 is prevented from flowing into the thrust dynamic pressure bearing portion including the thrust dynamic pressure grooves 4241, the lower gap 63, and the thrust plate 5. Accordingly, it is possible to avoid the solidified adhesive contacting and scraping against the thrust plate 5 during rotation of the motor, and also to prevent interruption of circulation of the lubricant oil.

Further, since the raised portion 4242 is disposed between the thrust dynamic pressure grooves 4241 and the step portion 412, it is possible to easily prevent the adhesive from spreading radially inside the step portion 412 while avoiding the raised portion 4242 and the step portion 412 obstructing each other in inserting the sleeve 42 into the sleeve housing 41.

Furthermore, when the height of the raised portion 4242 is larger than the depth of the thrust dynamic pressure grooves 4241, it is possible to reliably prevent the inflow of the surplus adhesive 9 into the thrust dynamic pressure grooves 4241.

And besides, as shown in FIGS. 4 and 6, the surface profiles of the lower end surface 424 and the upper end surface 422 of the sleeve 42 are greatly different from each other, discrimination between the upper side and the lower side of the sleeve 42 can be easily made during assembly. Therefore, it is possible to prevent the sleeve 42 from being inserted upside down into the sleeve housing 41.

In the bearing assembly 4, the raised portion 4242 and the slant surface 4122 of the step portion 412 allow much surplus adhesive 9 to be retained thereat. Even if the slant surface 4122 is not provided, it is possible to sufficiently prevent the inflow of the surplus adhesive 9 toward the thrust plate 5 with the raised portion 4242 alone by enhancing accuracy in controlling the amount of adhesive to be applied to a certain degree. This holds true for other embodiments to be described hereinafter. A recessed portion in the form of a step may be provided instead of the slant surface 4122, i.e., the slant surface 4122 may be formed into a recessed shape.

### Second Preferred Embodiment

FIG. 9 is a bottom view of a sleeve 42a of a bearing assembly according to a second preferred embodiment of the present invention. In the bearing assembly according to the second preferred embodiment, a recessed portion 4242a centered at the center axis J1 is provided on the lower end surface 424 of the sleeve 42a, instead of the raised portion 4242 of FIG. 6. Except for the above, the configurations of the sleeve 42a and the bearing assembly are approximately the same as those of the sleeve 42 and the bearing assembly 4 shown in FIGS. 4 to 7, and like reference numerals are given to like configurations.

As on the lower end surface 424 of FIG. 6, a group of a plurality of thrust dynamic pressure grooves 4241, in the form of spiral grooves, for example, are provided on the lower end surface 424 of the sleeve 42a. In FIG. 9, the bottom surfaces of the thrust dynamic pressure grooves 4241 are hatched.

A thrust dynamic pressure bearing portion is defined by the lower end surface 424 of the sleeve 42a and the thrust plate 5. The recessed portion 4242a is disposed between the thrust dynamic pressure grooves 4241 and the outer peripheral edge 4244 of the lower end surface 424. A flat region is provided between the recessed portion 4242a and the chamfered outer peripheral edge 4244. The flat region is situated at approximately the same level as the bottom surfaces of the thrust dynamic pressure grooves 4241. That is, the flat region is the hatched region around the outer periphery of the recessed portion 4242a. Four radial recessed grooves 661a are provided in this area, and the depth of the grooves 661a is almost the same as that of the recessed portion 4242a.

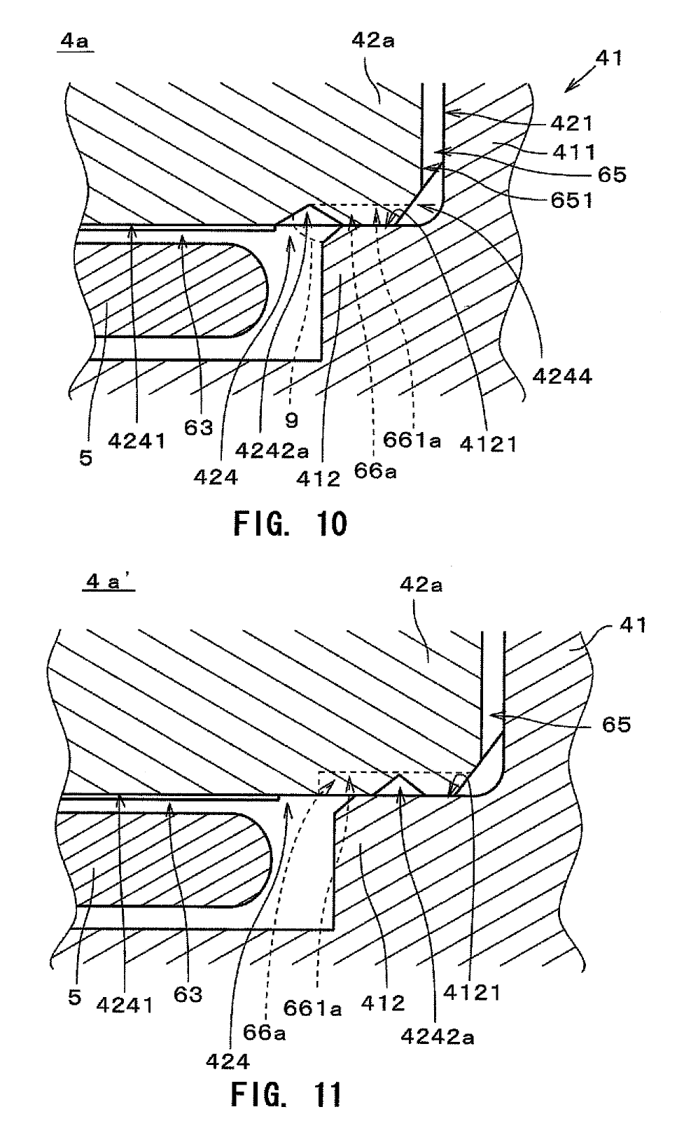

FIG. 10 is an enlarged cross-sectional view showing a portion of the bearing assembly 4a according to the second preferred embodiment. FIG. 10 corresponds to FIG. 7. The recessed portion 4242a on the lower end surface 424 of the sleeve 42a has an approximately triangular shape in cross section with its upper side projecting in inverted V-shape. The recessed portion 4242a faces the step portion 412 with a gap therebetween and also faces the thrust plate 5 with a gap therebetween.

The depth of the recessed portion 4242a is larger than that of the thrust dynamic pressure grooves 4241. In FIG. 10, the depth of the thrust dynamic pressure grooves 4241 is in the range from about 10 to about 14 μm, and the depth of the recessed portion 4242a is in the range from about 0.05 to about 0.3 mm. It should be noted that the depth of the recessed portion 4242a may be approximately the same as the depth of the thrust dynamic pressure grooves 4241.

The region between the recessed portion 4242a and the outer peripheral edge 4244 of the lower end surface 424 comes into contact with the upper surface 4121 of the step portion 412 of the sleeve housing 41. The grooves 661a (see FIG. 9) form four radially extending flow passages 66a with the step portion 412. In FIG. 10, the bottom of a groove 661a is shown with a broken line.

As shown in FIGS. 9 and 10, the lower ends of the three grooves 651 that extend from the lower end surface 424 to the upper end surface 422 (see FIG. 4) of the sleeve 42 are located at the outer peripheral edge 4244. The grooves 651 form the flow passages 65 substantially parallel to the center axis J1 when the outer side surface 421 of the sleeve 42a is covered with the inner side surface of the hollow portion 411.

In the bearing assembly 4a of this preferred embodiment, the flow passages 66a as the first communicating flow passages defined by the grooves 661a, the flow passages 65 as the second communicating flow passages defined by the grooves 651, and the gaps 61, 62, and 63 (see FIG. 3) collectively configure circulating paths for circulating the lubricant oil. The lubricant oil circulates in such a manner that it flows through the side gap 62 and then the lower gap 63, past the flow passages 66a, the flow passages 65, and the upper gap 61, to return to the side gap 62.

Also in the assembly of the bearing assembly 4a, the adhesive 9 (shown with a broken line) can be prevented from spreading by the recessed portion 4242a as the adhesive stopping feature even when the surplus adhesive 9 flows through between the lower end surface 424 of the sleeve 42a and the step portion 412 of the sleeve housing 41 toward the thrust plate 5, as in the bearing assembly 4 shown in FIG. 8.

In this manner, the adhesive 9 can be prevented from flowing into the thrust dynamic pressure bearing portion provided at the gap 63. Accordingly, it is possible to avoid the solidified adhesive scraping against the thrust plate and to prevent the adhesive from interrupting the circulation of the lubricant oil at the same time. Since the recessed portion 4242a does not touch the step portion 412, design of the sleeve 42a with consideration of precision in forming is facilitated.

FIG. 11 shows a variant of the bearing assembly 4a′ according to the second preferred embodiment. In a bearing assembly 4a shown in FIG. 11, the recessed portion 4242a shown in FIG. 10 is disposed on the lower end surface of the sleeve 42a at a position facing the top surface 4121 of the step portion 412 of the sleeve housing 41. The plurality of grooves 661a extending radially on the lower end surface 424 of the sleeve 42a traverse the recessed portion 4242a as well as the top surface 4121 of the step portion 412. With this structure, the flow passages 66a that connect the lower gap 63 with the flow passages 65 are formed.

The bearing assembly 4a shown in FIG. 11 can provide similar effects to those obtained by the first and second preferred embodiments. Since the recessed portion 4242a is disposed over the upper surface 4121 of the step portion 412, it is possible to prevent the spread of the surplus adhesive. It is also possible to prevent the inflow of the adhesive into the thrust dynamic pressure grooves 4241 or the thrust plate 5. Consequently, it is possible to prevent the solidified adhesive from scraping against the thrust plate and interrupting the circulation of the lubricant oil. Also, as the recessed portion 4242a does not touch the step portion 412, it is possible to easily increase the radial dimension of the thrust dynamic pressure grooves 4241 on the lower end surface of the sleeve.

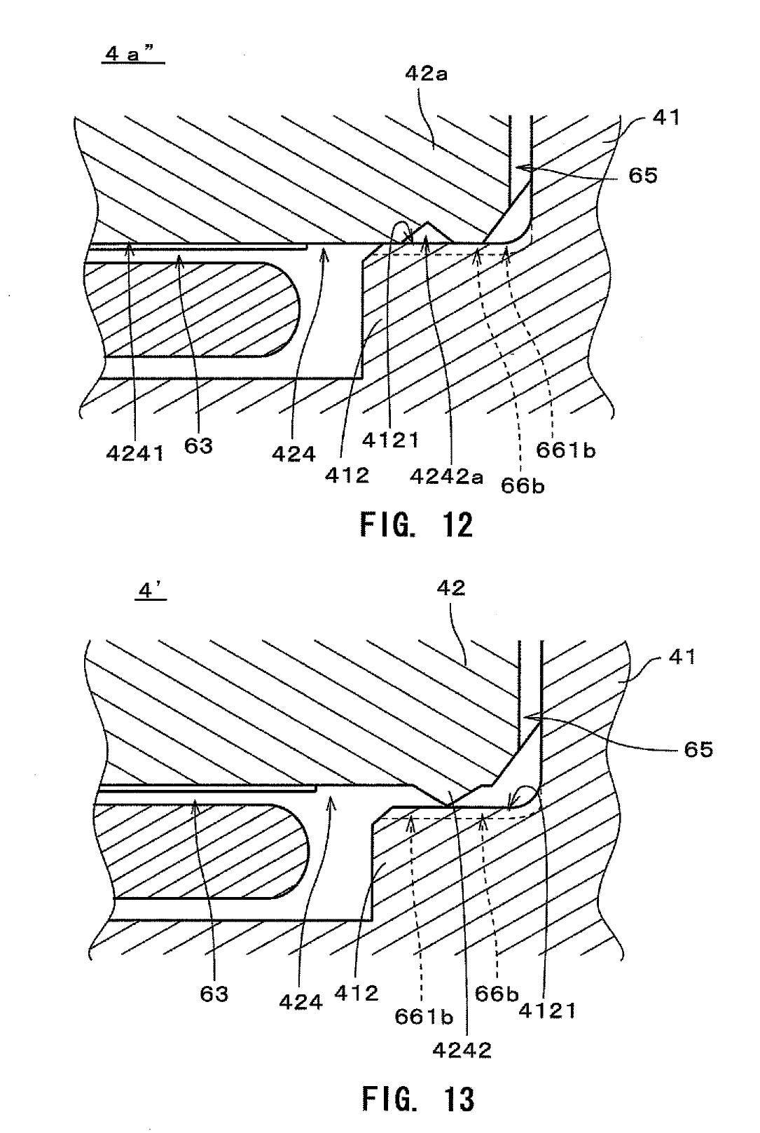

FIG. 12 shows another variant of the bearing assembly 4a″ according to the second preferred embodiment. In a bearing assembly 4a″ shown in FIG. 12, there are provided a plurality of grooves 661b radially extending on the top surface 4121 of the step portion 412, instead of the radial grooves 661a shown in FIG. 11. The grooves 661b are covered with the lower end surface 424 of the sleeve 42a, so that a plurality of flow passages 66b extending in the radial direction are formed to connect the lower gap 63 with the flow passages 65.

The bearing assembly 4a″ shown in FIG. 12 can also provide similar effects to those obtained by the first and second preferred embodiments. The recessed portion 4242a provided on the lower end surface 424 of the sleeve 42a prevents the spreading of the surplus adhesive that has appeared in assembling the sleeve 42a and the sleeve housing 41, toward the thrust dynamic pressure bearing portion. And besides, since the recessed portion 4242a is disposed over the step portion 412, it is possible to easily increase the radial dimension of the thrust dynamic pressure grooves 4241.

Note that in the bearing assembly 4a shown in FIG. 10, the grooves 661b shown in FIG. 12 may be provided on the step portion 412, instead of the grooves 661a.

FIG. 13 shows a variant of the bearing assembly 4 according to the first preferred embodiment shown in FIG. 7. In the bearing assembly 4′ of FIG. 13, the raised portion 4242 is disposed on the lower end surface 424 of the sleeve 42 in the bearing assembly 4 of FIG. 7, and is arranged above the step portion 412. In addition, a plurality of radially extending grooves 661b similar to those shown in FIG. 12 are provided on the top surface 4121 of the step portion 412. The projections 4245 shown in FIG. 7 are not provided. Except for the above, the baring assembly 4′ is approximately the same as those of the bearing assembly 4 according to the first preferred embodiment.

In the bearing assembly 4 of FIG. 13, although the raised portion 4242 comes into contact with the top surface 4121 of the step portion 412, the grooves 661b form flow passages 66b that connect the lower gap 63 with the flow passages 65 for circulating the lubricant oil. With this configuration, the inflow of the adhesive into the thrust dynamic pressure bearing portion can be prevented by the raised portion 4242 as the adhesive stopping feature, while circulation of the lubricant oil can be ensured.

It should be noted that in place of the grooves 661b, a groove in a recessed shape extending in the radial direction may be provided on the raised portion 4242. Also, the grooves 661b shown in FIG. 13 may be provided on the step portion 412 in the bearing assembly 4 shown in FIG. 7.

### Third Preferred Embodiment

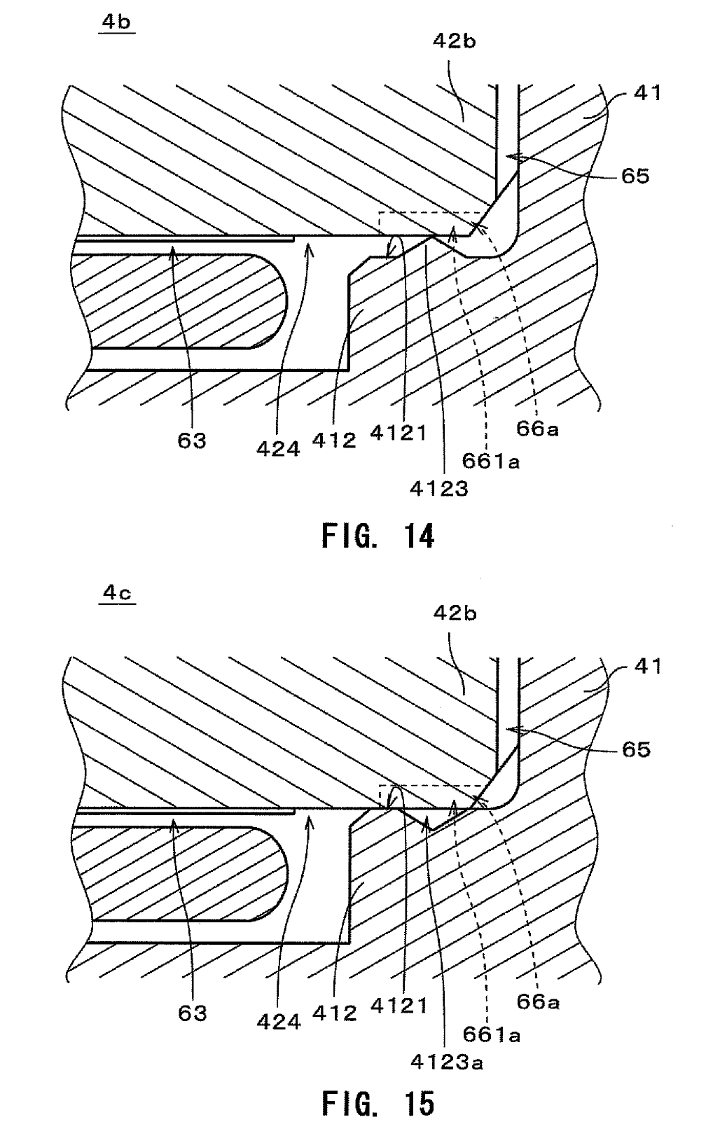

FIG. 14 shows a portion of a bearing assembly 4b according to a third preferred embodiment. The bearing assembly 4b includes a raised portion 4123 on the top surface 4121 of the step portion 412, instead of the raised portion 4242 of the bearing assembly 4 shown in FIG. 13. The raised portion 4123 of this preferred embodiment is approximately annular and is centered at the center axis J1 (see FIG. 3). Moreover, instead of the radial grooves 661b on the step portion 412 shown in FIG. 13, the bearing assembly 4b includes a plurality of radially extending grooves 661a provided in a rim area of the lower end surface 424 of a sleeve 42b. The grooves 661a form flow passages 66a as the first communicating flow passages that connect the lower gap 63 with the flow passages 65 as the second communicating flow passages. Except for the above, the bearing assembly 4b is approximately the same as the bearing assembly 4′ shown in FIG. 13.

The bearing assembly 4b shown in FIG. 14 can also provide similar effects to those obtained by the foregoing first and second preferred embodiments. That is, the raised portion 4123 prevents the surplus adhesive that appears during the assembly of the sleeve 42b and the sleeve housing 41 from flowing into the thrust dynamic pressure bearing portion while the circulation of the lubricant oil is ensured.

### Fourth Preferred Embodiment

FIG. 15 shows a portion of a bearing assembly 4c according to a fourth preferred embodiment. The bearing assembly 4c of this preferred embodiment includes a recessed portion 4123a on the top surface 4121 of the step portion 412, instead of the raised portion 4123 of the bearing assembly 4b shown in FIG. 14. The recessed portion 4123a is approximately annular and centered on the center axis J1, for example. Except for the above, the bearing assembly 4c is approximately the same as the bearing assembly 4b of FIG. 14. The radial grooves 661a provided in the outer peripheral region of the lower end surface 424 of the sleeve 42b form the flow passages 66a as the first communicating flow passages that connect the lower gap 63 with the flow passages 65 as the second communicating flow passages.

The bearing assembly 4c shown in FIG. 15 can also provide similar effects to those obtained by the foregoing first, second, and third preferred embodiments. That is, the recessed portion 4123a as the adhesive stopping feature prevents the surplus adhesive that appears during the assembly of the sleeve 42b and the sleeve housing 41 from flowing into the thrust dynamic pressure bearing portion while the circulation of the lubricant oil is ensured.

In each of the bearing assemblies 4b and 4c shown in FIGS. 14 and 15, a groove forming a flow passage connecting the lower gap 63 with the flow passages 65 may be provided on the top surface 4121 of the annular step portion 412. That is, in FIG. 14, the raised portion 4123 may be provided with a radial groove in a recessed shape instead of the grooves 661a, and in FIG. 15, a radial groove traversing the annular recessed portion 4123a may be provided.

As has been described in the foregoing first to fourth preferred embodiments, the raised portion or the recessed portion as the adhesive stopping portion for preventing the inflow of the surplus adhesive into the thrust dynamic pressure bearing portion may be provided on the sleeve, or may be provided on the step portion 412 of the sleeve housing 41.

In either case, the groove(s) forming the radial flow passage(s) connecting the lower gap 63 with the flow passages 65 may be provided either on the sleeve or on the step portion 412, so long as the radial flow passage(s) is/are secured between the lower end surface 424 of the sleeve and the step portion 412.

### Fifth Preferred Embodiment

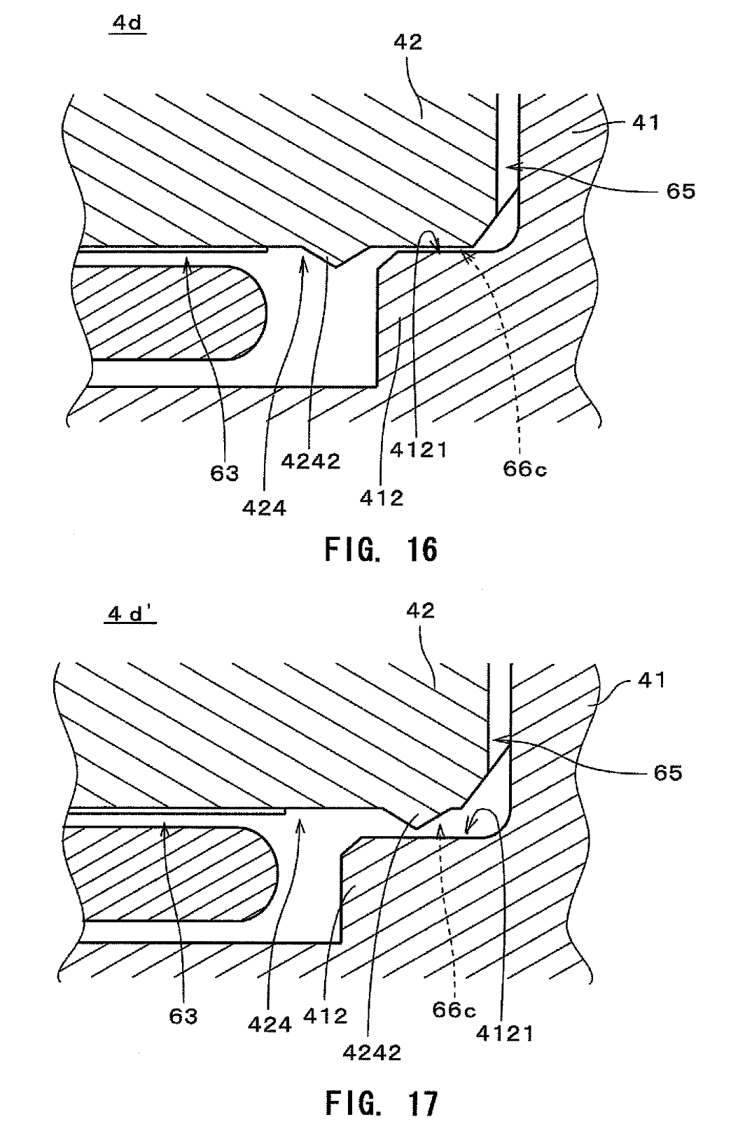

FIG. 16 shows a portion of a bearing assembly 4d according to a fifth preferred embodiment. The bearing assembly 4d has substantially the same configuration as the bearing assembly 4 of FIG. 7, except that the projections 4245 (or the grooves 661) in the outer peripheral region of the lower end surface 424 of the sleeve 42 are omitted. The outer peripheral region of the lower end surface 424 and the top surface 4121 of the step portion 412 face each other to form a gap, and this gap becomes a flow passage 66c as the first communicating flow passage that connects the lower gap 63 with the flow passages 65 as the second communicating flow passages. Thus, the bearing assembly 4d can provide similar effects to those of the foregoing embodiments. Circulation of the lubricant oil can be ensured, and at the same time, the inflow of the surplus adhesive into the thrust dynamic pressure bearing portion can be prevented by the raised portion 4242.

FIG. 17 shows a variant of the bearing assembly 4d shown in FIG. 16. In a bearing assembly 4d′ shown in FIG. 17, the raised portion 4242, which is the lowermost portion in the lower end surface 424 of the sleeve 42, opposes the top surface 4121 of the step portion 412 with a predetermined gap therebetween. In other words, the bearing assembly 4d shown in FIG. 17 has a configuration in which the grooves 661b are omitted in the bearing assembly 4 shown in FIG. 13 and a gap is provided between the raised portion 4242 and the step portion 412. This gap becomes a flow passage 66c as the first communicating flow passage that connects the lower gap 63 with the flow passages 65 as the second communicating flow passages.

### Sixth Preferred Embodiment

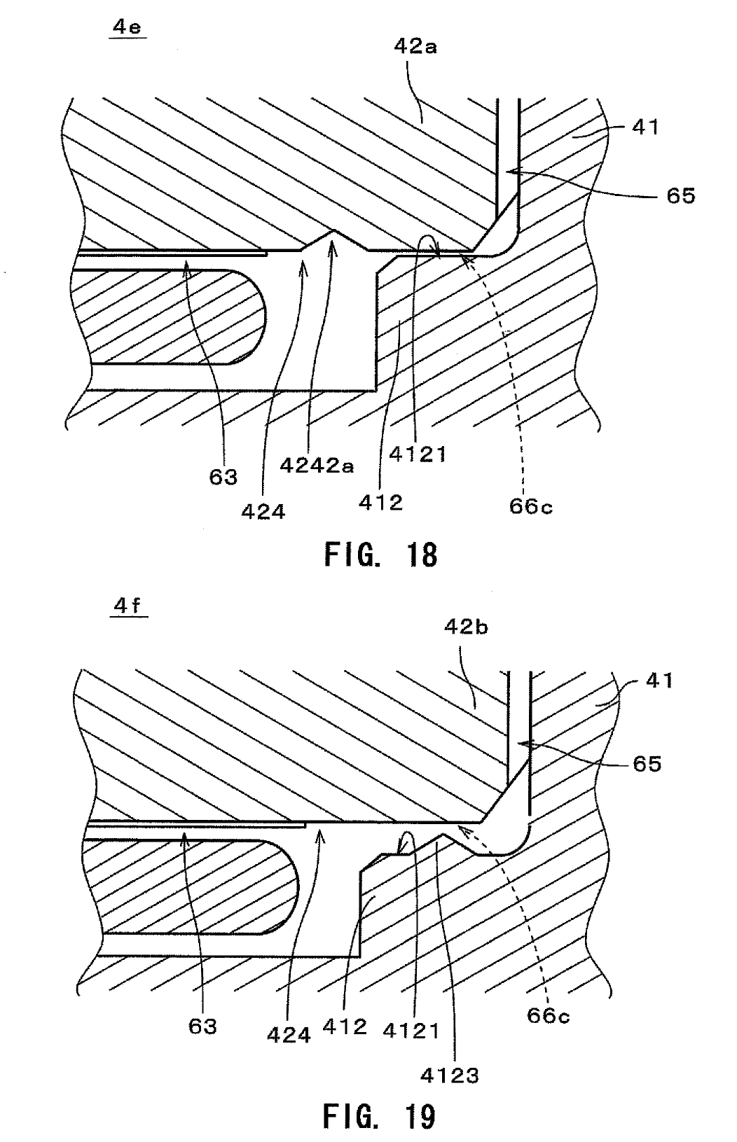

FIG. 18 shows a portion of a bearing assembly 4e according to a sixth preferred embodiment. The bearing assembly 4e has substantially the same configuration as that of the bearing assembly 4a shown in FIG. 10, except that the grooves 661a in the outer peripheral region of the lower end surface 424 of the sleeve 42a are omitted and a gap is provided between the outer peripheral region of the lower end surface 424 and the top surface 4121 of the step portion 412. This gap becomes a flow passage 66c as the first communicating flow passage that connects the lower gap 63 with the flow passages 65 as the second communicating flow passages. Thus, the bearing assembly 4e can provide similar effects to those of the foregoing embodiments. The recessed portion 4242a prevents the inflow of the surplus adhesive into the thrust dynamic pressure bearing portion.

It should be noted that in the bearing assembly 4a shown in FIG. 11 or 12, the grooves 661a or the grooves 661b may be removed, and that a gap may be provided between the lower end surface 424 of the sleeve 42a and the upper surface 4121 of the step portion 412 so as to form a first communicating flow passage.

### Seventh Preferred Embodiment

FIG. 19 shows a portion of a bearing assembly 4f according to a seventh preferred embodiment. The bearing assembly 4f has substantially the same configuration as the bearing assembly 4b shown in FIG. 14, except that the grooves 661a in the outer peripheral region of the lower end surface 424 of the sleeve 42b are omitted and a gap is provided between the outer peripheral region of the lower end surface 424 and the raised portion 4123, which is the uppermost portion in the top surface 4121 of the step portion 412.

This gap becomes a flow passage 66c as the first communicating flow passage that connects the lower gap 63 with the flow passages 65 as the second communicating flow passages. Thus, the bearing assembly 4f can provide similar effects to those of the foregoing embodiments can be obtained. The raised portion 4123 prevents the inflow of the surplus adhesive into the thrust dynamic pressure bearing portion.

### Eighth Preferred Embodiment

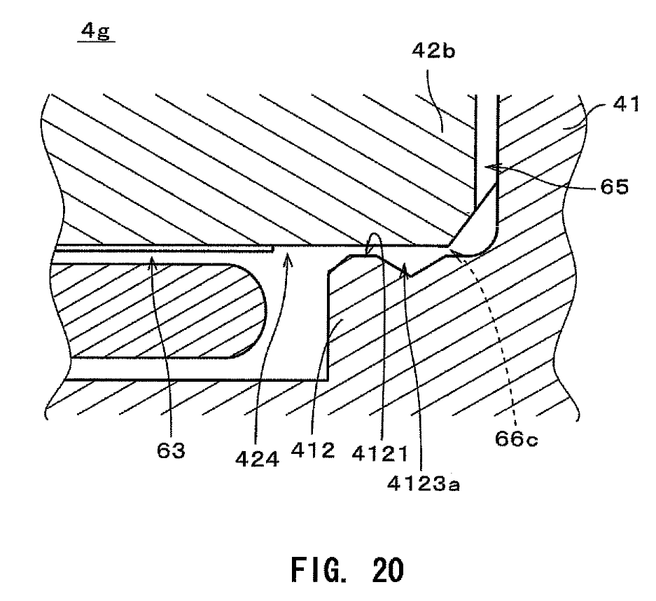

FIG. 20 shows a portion of a bearing assembly 4g according to an eighth preferred embodiment. The bearing assembly 4g has substantially the same configuration as the bearing assembly 4c shown in FIG. 15, except that the grooves 661a in the outer peripheral region of the lower end surface 424 of the sleeve 42b are omitted and a gap is provided between the outer peripheral region of the lower end surface 424 and the top surface 4121 of the step portion 412.

This gap becomes a flow passage 66c as the first communicating flow passage that connects the lower gap 63 with the flow passages 65 as the second communicating flow passages. Thus, the bearing assembly 4g can provide similar effects to those of the foregoing embodiments can be obtained. The recessed portion 4123a as the adhesive stopping feature on the step portion 412 prevents the inflow of the surplus adhesive into the thrust dynamic pressure bearing portion.

As shown in FIGS. 16 to 20, the first communicating flow passage(s) is/are not necessarily formed by the groove(s) provided on the sleeve or the sleeve housing 41, and may be provided as a gap between the lower end surface 424 of the sleeve and the top surface 4121 of the step portion 412. Obviously, a radial groove may be provided on the lower end surface 424 of the sleeve or on the top surface 4121 of the step portion 412 in each of the bearing assemblies shown in FIG. 16 to 20, in order to guarantee the provision of the first communicating flow passage.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

In each of the foregoing embodiments, the flow passages 65 as the second communicating flow passages are provided by the formation of the grooves 651 on the outer surface 421 of the sleeve; however, the present invention is not limited thereto, and the second communicating flow passages may be provided by forming grooves parallel to the center axis J1 on the inner side surface of the hollow portion 411 of the sleeve housing 41. Moreover, in each of the foregoing embodiments, the plurality of flow passages 65 are provided as the second communicating flow passages and the plurality of flow passages are provided as the first communicating flow passages; however, the present invention is not limited thereto, and the number of the first and second communicating flow passages may be one, respectively.

In each of the bearing assemblies according to the foregoing embodiments, the thrust dynamic pressure bearing portion is provided at the upper gap 61 as shown in FIGS. 3 and 4, but the present invention is not limited thereto. For example, the thrust dynamic pressure grooves may be provided on the upper end surface of the sleeve housing 41, such that a thrust dynamic pressure bearing portion is configured between the circular disk portion of the rotor hub and the sleeve housing. The technique of providing the above described annular raised portion or annular recessed portion on the lower end surface of the sleeve may be employed in bearing assemblies where a thrust dynamic pressure bearing portion is not provided at the lower side of the circular disk portion.

The thrust dynamic pressure grooves disposed on the lower end surface of the sleeve maybe provided in a herringbone arrangement, and the thrust dynamic pressure grooves disposed on the upper end surface of the sleeve may be provided in a spiral arrangement.

Furthermore, the shaft to be inserted in the sleeve may be a separate member from the rotor hub. In this case, the shaft and the thrust plate part may be formed into a single member. The shape of the sleeve housing is not limited to bottomed cylindrical; for example, the sleeve housing may take a substantially cylindrical shape, and a structure for preventing leakage of the lubricant oil, such as a tapered seal, may be appropriately provided at the lower side of the sleeve housing.

The motor according to the foregoing embodiments not necessarily has a configuration in which the rotor magnet is disposed outside the stator; alternatively, the rotor magnet may be disposed radially inside the stator.

Further, the motor may be used as a drive source of a recording disk drive of a type other than the hard disk drive (e.g., a removable disk drive or a read-only device of recording disks), or may be used for different purposes from the drive source of the recording disk drives.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A bearing assembly using a hydrodynamic pressure, comprising:
a shaft centered on a center axis;
a hollow sleeve operable to receive the shaft therein and centered in the center axis, one of the shaft and the sleeve being rotatable about the center axis relative to the other;
a thrust plate in the form of a substantially circular plate extending from a lower portion to outside in a radial direction perpendicular to or substantially perpendicular to the center axis, the thrust plate facing a lower end surface of the sleeve and being smaller in outer diameter than the lower end surface of the sleeve; and
a sleeve housing arranged outside the sleeve and the thrust plate in the radial direction, wherein
the sleeve housing includes:
a hollow portion, approximately cylindrical, having an inner side surface to which an outer side surface of the sleeve is bonded with adhesive; and
a step portion projecting radially inward from an inner side surface of the hollow portion and being in contact with the lower end surface of the sleeve, the sleeve is provided with a thrust surface and an adhesive stopping feature on its lower end surface, the thrust surface facing the thrust plate, the adhesive stopping feature arranged between the thrust surface and the outer side surface of the sleeve, and
a first communicating groove and a second communicating groove are provided between the sleeve and the sleeve housing, the first communicating groove extending in the radial direction between the lower end surface of the sleeve and the step portion, the second communicating groove axially extending between the outer side surface of the sleeve and the hollow portion of the sleeve housing, the first communicating groove being in communication with the second communicating groove.

2. The bearing assembly according to claim 1, wherein a plurality of thrust dynamic pressure grooves are formed in the thrust surface for generating a hydrodynamic pressure of lubricant during rotation of one of the sleeve and the shaft relative to the other.

3. The bearing assembly according to claim 2, wherein the adhesive stopping feature is a raised portion and a height of the raised portion is approximately the same as or larger than a depth of the thrust dynamic pressure grooves.

4. The bearing assembly according to claim 2, wherein the adhesive stopping feature is a recessed portion and a depth of the recessed portion is approximately the same as or larger than a depth of the thrust dynamic pressure grooves.

5. The bearing assembly according to claim 1, wherein the adhesive stopping feature is provided between the thrust surface and the step portion.

6. The bearing assembly according to claim 1, wherein the adhesive stopping feature is a recessed portion which is substantially annular, and
the recessed portion is in communication with the first communicating groove.

7. The bearing assembly according to claim 1, wherein
a side gap is defined between the shaft and the sleeve,
a lower gap is defined between the lower end surface of the sleeve and the thrust plate, and
the lubricant flows through the side gap, the lower gap, the first path, and the second path in that order.

8. The bearing assembly according to claim 1, wherein one of the sleeve and the sleeve housing has the first communicating groove and a projection adjacent to the first communicating groove.

9. An electric motor comprising:
the bearing assembly according to claim 1;
a rotor portion attached to an upper portion of the shaft; and
a stationary portion attached to the sleeve housing.

10. A disk drive comprising:
a disk-shaped storage medium capable of storing data;
the electric motor according to claim 8 operable to rotate the disk-shaped storage medium;
an access unit operable to carry out one of reading data from and writing data on the disk-shaped storage medium; and
a housing operable to accommodate the electric motor and the access unit.

11. A bearing assembly comprising:
a shaft and a hollow sleeve receiving the shaft therein, one of the shaft and the sleeve being rotatable about a center axis relative to the other;
a thrust plate extending from a lower portion of the shaft outward in a radial direction perpendicular to or substantially perpendicular to the center axis, facing a lower end surface of the sleeve, and being smaller in outer diameter than the lower end surface; and
a sleeve housing arranged outside the sleeve and the thrust plate, and including a hollow portion, which has an inner side surface bonded to an outer side surface of the sleeve with adhesive, and a step portion which projects radially inward from the inner side surface of the hollow portion and is in contact with a radially outer portion of the lower end surface of the sleeve, wherein
the sleeve is provided, on the lower end surface, with a thrust surface facing the thrust plate,
the step portion of the sleeve housing is provided with an adhesive stopping feature facing the lower end surface of the sleeve,
a first communicating groove and a second communicating groove are provided between the sleeve and the sleeve housing, the first communicating groove radially extending between the lower end surface of the sleeve and the step portion of the sleeve housing, the second communicating groove axially extending between the outer side surface of the sleeve and the inner side surface of the hollow portion of the sleeve housing, the first communicating groove being in communication with the second communicating groove.

12. The bearing assembly according to claim 11, wherein the thrust surface is provided with thrust dynamic pressure grooves for generating a hydrodynamic pressure in lubricant during rotation of one of the sleeve and the sleeve housing relative to the other.

13. The bearing assembly according to claim 12, wherein the adhesive stopping feature of the step portion is a raised portion and a height of the raised portion is approximately the same as or larger than a depth of the thrust dynamic pressure generating grooves.

14. The bearing assembly according to claim 12, wherein the adhesive stopping feature of the step portion is a raised portion and a height of the raised portion is approximately the same as or larger than a depth of the thrust dynamic pressure generating grooves.

15. The bearing assembly according to claim 11, wherein the adhesive stopping feature is a recessed portion which is substantially annular, and
the recessed portion is in communication with the first communicating groove.

16. The bearing assembly according to claim 11, wherein one of the sleeve and the sleeve housing has the first communicating groove and a projection adjacent to the first communicating groove.

17. An electric motor comprising:
the bearing assembly according to claim 11;
a rotor portion attached to an upper portion of the shaft; and
a stationary portion to which the sleeve housing is attached.

18. A disk drive comprising:
a disk-shaped storage medium capable of storing data;
the electric motor according to claim 17 operable to rotate the disk-shaped storage medium;
an access unit operable to carry out one of reading data from and writing data on the disk-shaped storage medium; and
a housing operable to accommodate the electric motor and the access unit.

19. A bearing assembly comprising:
a shaft and a hollow sleeve receiving the shaft therein, one of the shaft and the sleeve being rotatable about a center axis relative to the other;
a thrust plate extending from a lower portion of the shaft outward in a radial direction perpendicular to or substantially perpendicular to the center axis, facing a lower end surface of the sleeve, and being smaller in outer diameter than the lower end surface; and
a sleeve housing arranged outside the sleeve and the thrust plate, and including a hollow portion, which has an inner side surface bonded to an outer side surface of the sleeve with adhesive, and a step portion which projects radially inward from the inner side surface of the hollow portion and faces an outer periphery of the lower end surface of the sleeve with a gap therebetween, wherein
the sleeve is provided, on the lower end surface, with a thrust surface facing the thrust plate,
one of the lower end surface of the sleeve and a top surface of the step portion of the sleeve housing is provided with an adhesive stopping feature in the form of a raised portion or a recessed portion,
a first communicating groove and a second communicating groove are provided between the sleeve and the sleeve housing, the first communicating groove radially extending between the lower end surface of the sleeve and the step portion of the sleeve housing, the second communicating groove axially extending between the outer side surface of the sleeve and the inner side surface of the hollow portion of the sleeve housing, the first communicating groove being in communication with the second communicating groove.

20. The bearing assembly according to claim 19, wherein a plurality of thrust dynamic pressure grooves are formed in the thrust surface for generating a hydrodynamic pressure in lubricant during rotation of one of the sleeve and the sleeve housing relative to the other.

21. The bearing assembly according to claim 20, wherein the adhesive stopping feature is a raised portion and a height of the raised portion is approximately the same as or larger than a depth of the thrust dynamic pressure grooves.

22. The bearing assembly according to claim 20, wherein the adhesive stopping feature is a recessed portion and a depth of the recessed portion is approximately the same as or larger than a depth of the thrust dynamic pressure grooves.

23. The bearing assembly according to claim 19, wherein the adhesive stopping feature is formed on the lower end surface of the sleeve, and is arranged between the thrust surface and the outer side surface of the sleeve.
